(19) United States
(12) Patent Application Publication
(10) Pub. No.: US 2022/0030908 A1
(43) Pub. Date: Feb. 3, 2022

(54) PLANT PROTEIN AND ITS METHOD OF PREPARATION

(71) Applicant: ROQUETTE FRERES, Lestrem (FR)

(72) Inventors: Liuming ZHOU, GENEVA, IL (US); Mathias IBERT, LA CHAPELLE D'ARMENTIER (FR); Yufei HUA, Wuxi (CN); Caimeng ZHANG, Wuxi (CN); Xiangzhen KONG, Wuxi (CN); Yeming CHEN, Wuxi (CN); Xingfei Li, Wuxi (CN)

(21) Appl. No.: 17/277,617

(22) PCT Filed: Sep. 25, 2019
(86) PCT No.: PCT/EP2019/075837

§ 371 Date: Mar. 18, 2021

(30) Foreign Application Priority Data
Sep. 25, 2018 (EP) 18306248.8

(51) Int. Cl. A23J 1/14; A23J 3/14

(52) U.S. Cl. CPC A23J 1/14; A23J 3/14

(57) ABSTRACT

The invention relates to a plant protein isolate containing less than 10 microgram, preferably less than 5 microgram, of the sum of hexanal, 2-pentyl-furan, (E)-2,4,heptadienal and 1-octen-3-ol per gram of dry matter and its method of preparation. The plant protein is preferably obtained from leguminous plant, more preferably from pea or fava bean, most preferably from pea. The method for extracting the plant protein isolate consists of the steps: (a) providing a protein containing seed, (b) milling said seed, (c) suspending the milled seed in water, (d) extracting proteins from said milled suspension and (e) washing the extracted proteins with water at a temperature between 60° C. and 100° C. and at a pH in the range of 4 to 5.5.

### FIELD OF THE INVENTION

The present invention pertains to plant proteins, including isolate and concentrate, preferably leguminous protein isolates, more preferably pea protein isolates containing less than 10 μg of total volatile compounds per gram of dry matter. In comparison with plant protein isolates from prior art, such plant proteins, including isolate and concentrate, preferably leguminous protein isolates, more preferably pea protein isolates, clearly have the taste of low off-flavors when they are consumed. The invention further relates to processes of extraction and purification of the plant proteins, including isolate and concentrate, preferably leguminous protein isolates, more preferably pea protein isolates of the invention. Finally, the invention also relates to the application of plant proteins, including isolate and concentrate, preferably leguminous protein isolates, more preferably pea protein isolates, of the invention, in the food, feed and pharmaceutical industries.

### BACKGROUND OF THE INVENTION

Along with carbohydrates and lipids, proteins make up a significant part of our diet. The required amount of protein is generally said to be between 12% and 20% of our daily food intake.

The proteins consumed are generally either of animal origin, such as meats, fish, eggs and milk products, or of plant origin, including cereals, oleaginous plants and leguminous plants.

In industrialized countries, protein intake comes predominantly from proteins of animal origin. It is important to note that many studies show that excessive consumption of proteins that are of animal origin, and significantly less plant proteins, is one cause of the increase in the rates of cancers and cardiovascular diseases.

Moreover, animal proteins have many disadvantages, both in terms of their allergenicity, in particular with regards to proteins from milk and eggs, along with the degradation of our environment due to the intensive farming that is necessary for animal protein production.

Given this, manufacturers have gradually turned to plant proteins as an alternative to animal proteins. Indeed, it is known practice to use plant proteins to replace all or some of the animal proteins in food products.

This kind of replacement is not always easy, because the functional properties of plants proteins are different from those of animal proteins. In this case, functional properties refer to the physical or physicochemical properties that impact the sensory qualities of the food systems that have been generated during technological transformations, storage or domestic culinary preparations.

Among plant proteins, it is a well-known practice to use leguminous-plant proteins. Although milk proteins have a strong nutritional advantage, the high cost of production limits their use in large-scale food processing fields. As an alternative, leguminous-plant proteins can substitute milk proteins. Pea proteins in particular are now seen as game changing proteins in this field. Pea protein isolates are obtained from non-GMO sourced seeds, rather than soya protein isolates.

One drawback of certain plant proteins, particularly leguminous-plant proteins and pea proteins, is the fact that they are not tasteless. This means they can cause off-flavors, even in the products into which they are incorporated. Consumers frequently describe off-flavors as “a pea-like taste”, “beany taste”, “green taste” or “a plant-like taste”.

A well-known and simple solution is to mask the off-flavors during the formulation process, through the introduction of chemical compounds into the solution. This can be made of off-flavors maskers, flavorants and/or off-flavors modulators. Oftentimes, unfortunately, this type of solution does not entirely work, which means that rather than masking the off-flavors, they are merely reduced. An additional drawback is that formulators would have to buy additional compounds, thereby raising the cost of their formulation. Regulations, primarily food and pharmaceutical, can also be a hurdle for the use of such compounds. Another important factor is that today's consumer wants “clean label” products, and including these types of compounds on the product label would alienate some potential consumers

A more preferred solution is to work directly with a low off-flavor protein isolate, and there have already been some proposals for plant protein isolate producers in some solution.

For example, WO2015/071498 explains how to use a wet milling extraction process, combined with lactic acid fermentation, in order to extract a purified pea protein isolate. This process is able to produce a pea protein isolate with a mediocre kind of “good taste”, but it unfortunately fails to create a flavorless pea protein isolate. With reference to Table 10 of this patent application, every pea protein sample has continued to be described as having a “beany” or “pea-like” taste.

In another example, WO2017/120597 explains how to use a salting out precipitation, combined with a high volume protein washing specifically washing with high volumes of neutral pH and average temperature water. This process involves high amounts of salt and high volumes of neutral pH tap water (between 15 and 30 volumes of pea). Nevertheless, the «beany» and «bitter» tastes are still detected in pea protein isolates and are at the same level of an average commercial pea protein isolate (see graphs 18A, B and C).

Unfortunately, current commercial pea protein isolates are still developing off-flavors when they are consumed, often described as “beany” or “plant-like” off-tastes. There is still a need for tasteless leguminous protein isolates, preferably peas, without any off-flavors.

With that being said, the purpose of the present invention is to overcome or reduce at least one of the disadvantages of the prior art, and/or to provide a useful alternative.

### SUMMARY OF THE INVENTION

A first aspect of the present invention is plant protein, including isolate or concentrate, containing less than 10 μg of total volatile compounds per gram of dry matter, preferably below 5 μg of total volatile compounds per gram of dry matter.

In a preferred embodiment, total volatile compounds are to be understood as the sum of hexanal, 2-pentyl-furan, (E)-2,4, heptadienal and 1-octen-3-ol contents. Hence, in this embodiment, the plant protein isolate according to the invention contains less than 10 μg, preferably less than 5 μg of the sum of hexanal, 2-pentyl-furan, (E)-2,4, heptadienal and 1-octen-3-ol per gram of dry matter. In a more preferred embodiment, total volatile compounds are to be understood as the sum of all volatile compounds that are detected and analyzed by the method of the present invention, which is described below.

In a more preferred embodiment, the plant protein also contains less than 5 mg of total saponins per gram of dry matter.

In an even more preferred embodiment, plant protein is obtained from a leguminous plant, preferably from pea or fava bean, with pea protein being the most preferred.

All protein embodiments from the invention are characterized by a distinctly neutral taste, without “beany” or “plant-like” off-flavors. These embodiments are covered further in the detailed description of the invention, and in the list of the non-exhaustive examples.

Protein isolates according to the invention can also be characterized by an improved solubility in water compared to proteins from the prior art. Especially, protein isolates according to the invention possess a solubility in water at 20° C. and pH 6 above 30%, preferably above 40%, more preferably around 50% and a solubility at 20° C. and pH 7 above 40%, preferably above 60%, more preferably above 70%, determined according to the test described below.

A second aspect of the present invention is its method for obtaining plant protein, including isolate or concentrate, preferably leguminous protein isolate, more preferably pea protein isolate. The method consists of the following steps:

(a) providing a plant seed containing protein, preferably leguminous seed, more preferably pea seed;

(b) milling said seed;

(c) suspending the milled seed in water;

(d) extracting proteins from said milled suspension, preferably by thermocoagulation at isoelectric pH;

(e) washing proteins with water at a temperature between 60° C. and 100° C., more preferably between 75° C. and 95° c., and a pH c between 4 and 5.5, more preferably 4.5-5;

(f) optionally passing the washed proteins obtained at the end of step (e) through a shearing pump or a homogenizer to improve protein functionality;

(g) optionally drying the proteins obtained in step (e) or (f).

In a preferred embodiment, the milling of seed in step (b) is done directly in water and in the absence of oxygen, preferably in a residual concentration of dioxygen less than 300 μg/liter, preferably less than 200 μg/liter. Residual oxygen concentration may be determined according to the protocol described further on.

In a more preferred embodiment, the milling is done in the absence of additional water, and the milled suspension of step (c) is obtained by mixing dry flour and water. This would preferably be done in a residual concentration of dioxygen less than 300 μg/liter, preferably a measure of less than 200 μg/liter. Residual oxygen concentration may be determined according to by the protocol described further on.

A third aspect of the present invention is its involvement in the use of plant proteins, including isolate or concentrate, preferably leguminous protein isolates, more preferably pea protein isolates of the invention in food applications, feed applications, cosmetic applications and pharmaceutical applications.

The invention is better understood in going over the following detailed description.

### DETAILED DESCRIPTION OF THE INVENTION

The term “plant protein” is herein considered as all types of protein extracted from all types of plants. Plants must be understood as any of various photosynthetic, eukaryotic, multicellular organisms of the kingdom Plantae characteristically containing chloroplasts, having cell walls made of cellulose, producing embryos, and lacking the power of locomotion. Plants include trees, bushes, herbs, ferns, mosses, and certain green algae. Particularly in this application, the term plant applies to the leguminous family, which includes peas and fava bean. Other preferred types of plants are flax, oat, rice, and lentil.

“Protein” in this application is to be understood as referring to molecules, consisting of one or more long chains of amino-acid residues. In this application, proteins can be native to the plant or modified, including hydrolyzed proteins. These proteins can be of different concentrations, including isolates above 80% or concentrates above 50%.

The term “leguminous” must be understood as plants of the pea family (Leguminosae).

These have seeds in pods, distinctive flowers, and typically root nodules. These nodules contain symbiotic bacteria that are able to fix nitrogen.

The term “pea” is herein considered in the broadest of its acceptable senses. In particular, it includes all varieties of “smooth pea” and of “wrinkled pea”, and all mutant varieties of “smooth pea” and of “wrinkled pea». These varieties relate to the uses that are usually intended for each pea type (food for human consumption, animal feed and/or other uses). In the present application, the term “pea” includes the varieties of pea belonging to the Pisum genus and more particularly to the sativum and aestivum species. Said mutant varieties are in particular those known as “r mutants”, “rb mutants”, “rug 3 mutants”, “rug 4 mutants”, “rug 5 mutants” and “lam mutants” as described in the article by C-L HEYDLEY et al. entitled “Developing novel pea starches”, Proceedings of the Symposium of the Industrial Biochemistry and Biotechnology Group of the Biochemical Society, 1996, pp. 77-87.

The term “volatile” applies herein to the chemical compounds that evaporate readily at normal temperatures and pressures. These chemical compounds are easily analyzed using the chromatographic method as explained below.

The term “saponin” is herein considered as any of various plant glycosides that form soapy lathers when mixed and agitated with water. Specifically, these saponins are amphipathic glycosides grouped phenomenologically by the soap-like foam that is produced when the saponins are shaken in aqueous solutions. They are grouped structurally based on having one or more hydrophilic glycoside moieties, which is combined with a lipophilic triterpene derivative

As described above in the summary of the present invention, a first aspect of the present invention is a plant protein isolate, including isolate or concentrate, containing less than 10 μg of total volatiles compounds per gram of dry matter, preferably below 5 μg of total volatiles compounds per gram of dry matter.

In a preferred embodiment, the total volatile compounds must be understood as the sum of hexanal, 2-pentyl-furan, (E)-2,4, heptadienal and 1-octen-3-ol contents (see formulas in FIG. 1). In a more preferred embodiment, total volatile compounds must be understood as the sum of all volatile compounds detected and analyzed by the invention using the method described below. These particular volatile compounds are linked to the “beany”, “plant-like” or “pea-like” taste. The example below shows that the proteins of this invention contains less than 10 μg of these volatile compounds per gram of dry matter. Further along, in the example section of this application, it is shown that no commercial protein isolate or known extraction process (excluding use of solvent) has ever obtained this result.

In a more preferred embodiment, plant protein isolates contains also less than 5 mg of total saponins per gram of dry matter.

In an even more preferred embodiment, plant protein isolates are obtained from leguminous plants, preferably from pea or fava beans, with the most preferred coming from pea proteins.

The link between off-flavors and plant protein composition is well-known to men skilled in the art. The compounds that lead to such off-flavors can be categorized into two families. A man skilled in the art would describe the first family as comprised of volatile compounds with a typical molecular weight ranging from 30-300 g·mol⁻¹. Examples of such compounds are hexanal, 2-pentyl-Furan, etc. . . . . These volatile compounds often lead to the “beany”, “plant-like” and/or “pea-like” taste/off-flavor. If the link between off-flavors like “beany taste” or “pea-like taste” and volatile compounds is well-known, then it is also known that no process and no isolates currently available are able to reach low-enough level to result in almost no detection by the consumers of any off-flavors. There is only one process that involves use of solvent, which can be a serious drawback in the industrial process.

Such volatile compounds are present directly inside the leguminous plants, peas in particular, but they can also be synthesized during protein extraction by endogenous enzymes such as lipoxygenase, which will oxide residual lipids.

Total volatile compounds are evaluated by the HS-SPME analytical procedure. This procedure is done by examining the changes in the Sorayya & al., Volatile flavor profile of select field pea cultivars as they are affected by the crop year and processing, Food Chemistry, 124 (2011), 326-335. A 1 g pea protein sample is suspended in a 100 ml 15% (w/v) NaCl aqueous solution. After the 5 ml solution is mixed, it is placed in a sample bottle. SPME fiber (50/30 μm, DVB/CAR/PDMS, Supelco Co., Shanghai, China) is utilized for flavor extraction. Before each use, the fiber is conditioned at 250 for 1 hour. The 1 g pea protein sample is suspended in the 100 mL 15% (w/v) NaCl (AR) aqueous solution at room temperature. After mixing, the 5 ml of the solution is placed in a 30 mL clear glass vial (Supelco Co., Shanghai, China) then sealed with a lid containing Teflon-coated rubber septum, and fitted with a small magnetic stirring bar. Internal standard 2-methyl-3-heptanone (1 mg/L solution) (Sigma-Aldrich, Shanghai, China) is added. The sample in the vial is heated at 60° C. for 30 minutes in a water bath and extracted for 30 min using a SPME fiber, and the magnetic stirring rate of the adsorption process is 500 rpm. Then, the fiber is injected into the GC-MS (SCIONSQ-456-GC, Bruker, America), which is equipped with a capillary column with a polar resin of DB-WAX (30 m×0.25 mm i.d., 0.25 μm film thickness; Agilent Technologies Inc., Guangzhou, Guangdong, China). Splitless injections are used. The chromatograph temperature is programmed a t40° C., with an isotherm of 3 minutes, to 100° C. at a rate of 6° C. min⁻¹, then to 230° C. at a rate of 10° C. min⁻¹, with a final isotherm of 7 minutes. Mass spectrometry is operated in the electron impact mode at 70 eV. The mass spectrometer scans masses from m/z 33 to 350. The ionization source is set at 200° C. and the transfer line at 250° C. Volatile compounds are identified by making comparisons with a mass spectra library and by the calculation and comparison of the GC retention index of a series of alkanes (C8-C30). The retention index is based on published data that was calculated under the same chromatographic conditions. Quantification data are obtained by electronic integration of the areas under the total ionic current (TIC) peaks. Relative quantities are then calculated using the internal standard 2-methyl-3-cycloheptanone, and normalized by taking dry matter into account.

Regarding the second family linked to off-notes, a skilled man in the art knows of non-volatile compounds with typical molecular weight range of 40-1,000 g·mol⁻¹. For “Bitter” off-flavors, it is saponins, oxidized phospholipids, etc. . . . . For “Salty”, they are sodium chloride, potassium chloride, etc. For “Sour”, they are butyric acid, acetic acid, etc. Saponins and their bitter off-notes are the more challenging compounds in leguminous protein, particularly in peas.

Saponin extracts are analyzed following a modified protocol inspired of Lynn Heng & al., Bitterness of saponins and their content in dry peas, Journal of the Science of Food and Agriculture, 86 (2006), 1225-1231. and K. Decroos & al., Simultaneous quantification of differently glycosylated, acetylated, and 2,3-dihydro-2,5-dihydroxy-6-methyl-4H-pyran-4-one-conjugated soy saponins are performed using reversed-phase high-performance liquid chromatography with evaporative light scattering detection, Journal of Chromatography A, 1072 (2005) 185-193. The pea protein sample is defatted by hexane (AR, Sigma-Aldrich, Shanghai, China) then refluxing for 6 hours and subsequently the pea protein is air-dried in a fume hood overnight. Defatted pea protein (1 g) is extracted with 40 ml 60% (v/v) methanol (HPLC grade, Sigma-Aldrich, Shanghai, China) for 4 hours at 25° C. with constant shaking at 200 rpm in an incubator shaker (SWB15, Thermo Fisher, Shanghai, China). Prior to extraction, 100 mg kg⁻¹ of an internal standard, equilenin (an estrogen-like steroid, 3-hydroxyestra-1,3,5,7,9-pentaen-17-one) is added. The crude extract is filtered through an ashless filter paper (Whatman, 110 mm, Sinopharm Chemical Reagent Co., Ltd, Shanghai, China). The methanol from the clear filtrate is removed by evaporation under vacuum at 40° C. This evaporation step is performed in less than 15 minutes, using a 1 L round-bottom flask. The concentrates are made up to 5 mL with distilled water and passed through a Sep-Pak C18 solid-phase extraction column (Waters Plus tC18 cartridge, 37-55 μm, Suzhou, China), which is subsequently rinsed with 15 mL of water to remove unbound materials. The bound compounds are eluted with 10 ml 100% (v/v) methanol (HPLC grade, Sigma-Aldrich, Shanghai, China) and analyzed by LC-MS. The LC-MS chromatographic condition comes next. The capillary voltage is 4.4 KV, the cone hole voltage is 40V, the ion source temperature is 100° C., the dissolvent gas temperature is 250° C., the photoelectric multiplier voltage is 700 V, and the flow rate is 4.2 L/h. The liquid chromatographic is performed on a Waters 2690 liquid chromatograph system, which is equipped with a Lichrospher C-18 (2.1×250 mm, Waters) column and a detector Waters 996. The column temperature is 35° C., and the injection volume is at 10 uL with a flow rate of 0.3 mL/min. Gradient elution Conditions for LC-MS experiments are 0.5% formic acid (AR Sinopharm Chemical Reagent Co., Ltd, Shanghai, China), for 30 minutes (0-30 min), followed by a acetonitrile (HPLC grade, Sigma-Aldrich, Shanghai, China) to 0.5% formic acid ratio of 20:80 for 10 min (30-40 min), and a ratio of 40:60 for 1 minute (40-41 min), and then adjusted to 0.5% formic acid. The m/z ratio of the molecular ions [M+H]⁺ in the mass spectra of the peaks of DDMP saponin and saponin B were 1069 and 943, respectively. Relative quantities of saponins are calculated using the internal standard equilenin, and normalized by taking dry matter into account.

Protein isolates according to the invention can also be characterized by an improved solubility in water compared to proteins from the prior art. Especially, protein isolates according to the invention possess a solubility in water at 20° C. and pH 6 above 30%, preferably above 40%, more preferably around 50% and a solubility at 20° C. and pH 7 above 40%, preferably above 60%, more preferably above 70%.

Solubility can be measured with any method known in the art. Preferably, it will be measured using following protocol:
2.0 g sample and 100 g of distilled water are placed in a 400 mL beaker at 20° C.
pH is adjusted at 6 or 7, with 1N HCl and/or 1N NaOH and the mixture is made up to exactly 200.0 g with distilled water.
This mixture is stirred for 30 minutes and then centrifuged for 15 minutes at 3000×g.
After centrifugation, exactly 25.0 g of supernatant are withdrawn into a crystallizing dish (m1). The dish is placed in an oven at 103° C. until it reaches a constant mass (m2).

Solubility=((m2−m1)/25)*100

A second aspect of the present invention is its method for obtaining plant proteins, including isolate and concentrate, preferably leguminous protein isolates, more preferably pea protein isolates. This method involves the following steps: (a) providing a plant seed containing protein, preferably leguminous seed, more preferably pea seed;

(b) milling said seed;

(c) suspending the milled seed in water;

(d) extracting proteins from said milled suspension;

(e) washing proteins with water at a temperature between 60° C. and 100° C., more preferably between 75° C. and 95° c., and a pH within the range of 4 and 5.5, more preferably between 4.5 and 5;

(f) optionally passing the washed proteins obtained at the end of step (e) through a shearing pump or a homogenizer to improve protein functionality;

(g) optionally drying the proteins obtained in step (e) or (f).

In step (a), plant seeds suitable for this invention can be chosen from a list of food-compatible plant seeds, particularly pea, fava bean, oat, lentil, and flax . . . Pea seed is indeed the best and most suitable seed, followed closely by the fava bean.

Step (b) aims to mill the seed into flour, which can be done by every process known by those skilled in the art. It can include previous soaking, blanching or even the well-known roasting step, which is used to inhibit endogenous enzymes like lipoxygenases. The seed can be milled into flour before being mixed into water, a process known as “dry milling”. However, milling can also be done while seeds are suspended in water, also known as the “wet milling” process.

The goal of Step (c) is to suspend milled flour in water. In the case of wet milling, water is introduced before milling. In the process of dry milling, flour is introduced with water at a concentration of 20 to 30% by dry weight, preferably at 25% dry weight.

The goal of Step (d) is to extract protein from milled seeds. The wet extraction process is particularly suitable for this invention. A preferred process is described in its entirety in U.S. Pat. No. 7,186,807 (B2) which is incorporated into this application by reference.

In the first step of this patented process, the flour, which was obtained from milling of peas that had been cleaned, sorted, and blanched beforehand, is suspended in water. When suspending the flour in water, it is most advantageous to choose flour with a mean particle size that is equal to or less than 100 μm, at a concentration of 20 to 30% by dry weight, preferably at 25% dry weight. The pH of the solution is not a limiting factor, but it is most advantageous not to correct the pH of the suspension, which means working in a pH range between 6.2 and 7.

In the second step, it is most advantageous to directly expose this aqueous flour suspension to the process of the centrifugal decanter. This prevents the pea fiber fraction from being removed by prior sieving. The applicant company has observed that carrying out this separation operation with centrifugal decanters, according to a configuration used in a potato starch factory, makes it possible to easily separate, into two distinct fractions, the solubles and the proteins on the one hand, and the fibers and the starch on the other.

In the third step, the proteins are able to be isolated easily from the fraction containing the mixture of solubles and proteins thus obtained. This is accomplished by choosing one among several techniques to use for the precipitation of proteins at their isoelectric pH and/or of membrane separation of the ultrafiltration type. A preferred way is to use combined isoelectric pH and heat coagulation of proteins called “thermocoagulation”.

These obtained proteins, which are mainly globulins in the case of peas, are the raw material for step (e). The protein solution, which typically is less than 20% dry matter on commercial weight, is adjusted to a pH between 4 and 5.5, preferably to pH 4.5-5, more preferably to pH 4.5, preferably with citric acid, in a water bath with temperature between 60° C. and 100° C., more preferably between 75° C. and 95° C., even more preferably at about 90° C. Protein solution can be directly pumped into a plate filter or a centrifuge to separate whey, or after a contact time that can be up to 30 minutes. Then, protein curd can be washed, preferably 2 times, with between 1 and 5 volumes of water, at a pH adjusted between 4 and 5.5, preferably to a pH of 4.5-5, more preferably to pH 4.5, with the temperature between 60° C. and 100° C., more preferably between 75° C. and 95° C., even more preferably at about 90° C. Then, the washed protein curd is tacked out and re-suspended in distilled water so as to obtain a solids content ranging from 10% to 12%, and an adjusted pH between 6,5 and 7.0 with 2.0 M NaOH. One option for this step can be to end with high pressure homogenization (20 MPa) and spray drying. In an alternative embodiment, steps (d) and (e) can be done at the same time. In this case, proteins are coagulated, preferably thermocoagulated, after adding 1 to 5 volumes of water, by heating at a temperature between 60° C. and 100° C., more preferably between 75° C. and 95° C., even more preferably at about 90° C. and at pH 2,5. These three parameters are essential to obtain an isolate with sufficient organoleptic quality. The best results are obtained with 1 to 5 volumes of water, by heating at about 90° C. and at pH 4.5.

In a second preferred embodiment, the milling of seed in step (b) is done in the absence of oxygen. Absence of oxygen must be understood as residual content of oxygen less 300 ug/l, preferably less 200 ug/l. Residual oxygen content is measured with a common and known in the art apparatus, such as an oxygenmeter, preferably at 15° C. The preferred way is dry milling, but wet milling can also be used. With dry milling, oxygen can be analyzed by a tunable diode laser gas analyzer (TDL, Mettlo Toledo, Shanghai, China) whereas with wet milling; the oxygen can be analyzed using a dissolved oxygen analyzer (M400, Mettlo Toledo, Shanghai, China). Combining absence of oxygen during the milling step and the high temperature acid wash of step (d) seems to create a synergy and results in a high quality level leguminous pea protein isolate, preferably a pea protein isolate. Milling with low oxygen alone does not create proteins of good organoleptic quality, unlike the results from the present invention. Such low residual oxygen content can be obtained with well-known processes from the industry, such as purging nitrogen in a vessel where seeds are milled. In a more preferred embodiment, steps (c) and (d) are also done in the absence of oxygen, preferably with a residual content of oxygen less 300 μg/I, preferably less 200 μg/I. Using nitrogen in headspace of process apparatus and water without dissolved oxygen are common ways to ensure such an embodiment.

In both embodiments of step (d) as described above, an optional homogenization of the protein obtained can be done with a shear pump in order to raise solubility, if needed. Common known process like pasteurization or the introduction of food-grade auxiliary compounds can also be added to the process. At the end, the protein obtained can be dried with common technology such as a spray-drier.

The present invention will be better understood with reference to the following examples and figures. These examples are intended to representative of specific embodiments of the invention, and are not intended as limiting the scope of the invention.

### FIGURES

FIG. 1: Chemical structure of main volatile compounds linked to the “beany” or “vegetal” taste.

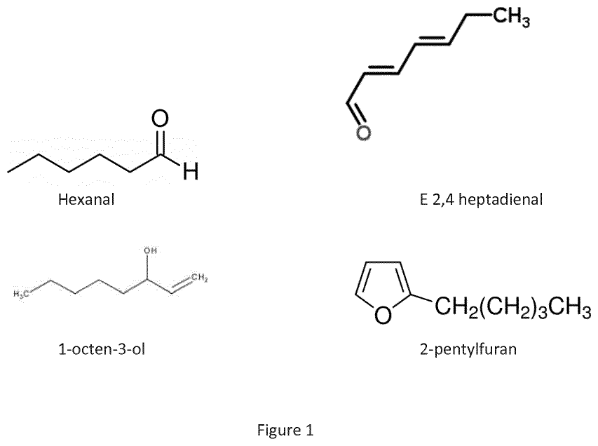

FIG. 2: Inventive process #1 according to Example 3—high temperature and acid wash.

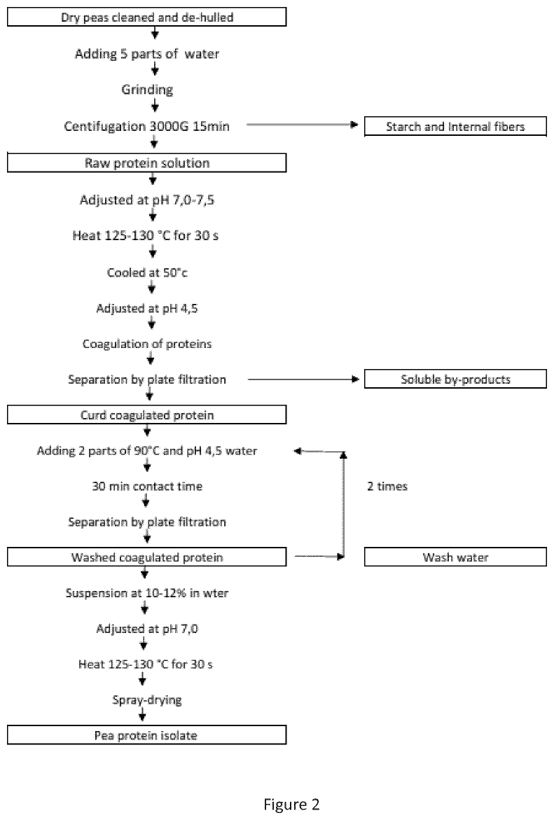

FIG. 3: Inventive process #2 according to Example 4—low oxygen grinding and high temperature acid wash.

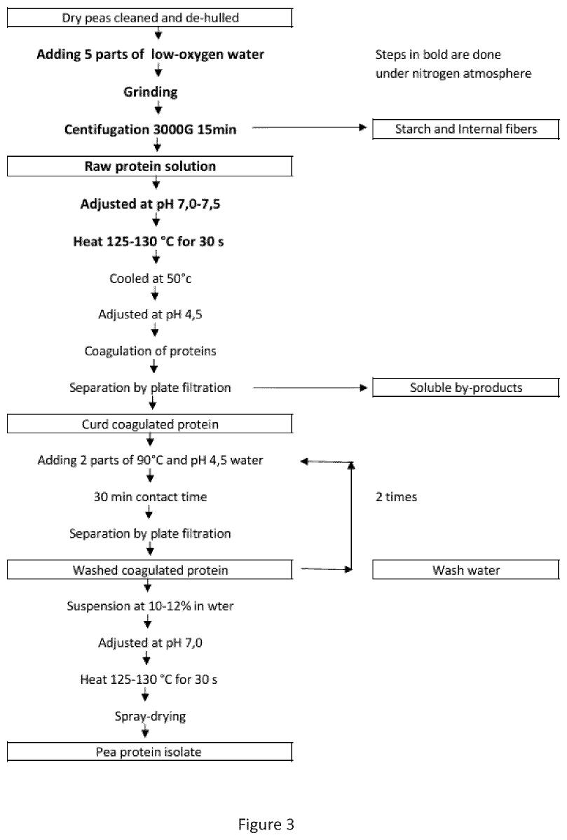

FIG. 4: Comparison of protein isolates from prior art and the invention.

### EXAMPLES

### Example 1: Prior Art Process #1, Involving Solvent Purification

This example demonstrates the reference protein in organoleptic point of view. It uses solvents that must be avoided from industrial point of view (explosion hazard, clean-label . . . ).

Cleaned and de-hulled dry yellow peas were grinded at 20° C., and then the pea flour was suspended in hexane-ethanol azeotropic mixture (82:18, v/v) at a ratio of 1:5 (w/v) at 4° C. to extract the lipids. The slurry was stirred at a low speed for 1.0 h and was then vacuum filtered. The filter cake was passed through a 20-mesh sifter. The procedure was repeated five times. The defatted pea flour was immersed in 95% (v/v) ethanol at 20° C. for 1.0 hour with a flour solvent ratio of 1:5 (w/v). After vacuum filtering, the cake was removed residual solvent by vacuum rotary evaporation at 60° C. The defatted pea flour was suspended in distilled water in a ratio of 1:9 (w/v) of flour to water, and the pH was adjusted to 7.0 with 2 mol L−1 NaOH. After stirring for 1.0 h at 20° C., the suspension was centrifuged at 3,000 g for 15 min to recover the supernatant (the protein fraction). The protein extracting solution was heated to 125-130° C. for 30 seconds directly through steam injection to inactivate the endogenous enzyme, and cooled to 50° C. using the plate heat exchanger, and then precipitated by adjusting the pH to 4.5 with 2 mol L−1 HCl and centrifuged at 3,000 g for 15 minutes. The protein curd was immersed in 85% (v/v) ethanol three times at 20° C. for 1.0 h at a ratio of 1:5 (w/v). After vacuum filtering, the cake removed residual solvent through vacuum rotary evaporation at 60° C. Then the alcohol washed protein flour was re-suspended in distilled water at a ratio of 1:9 (w/v) of flour to water, and neutralized the pH to 7.0 with 2 mol L−1 NaOH. The protein solution was freeze-dried to obtain pea protein isolates without any off-flavors. The sample “Prior art process #1-solvent” was obtained.

### Example 2: Prior Art Process #2, Involving Soaking, Wet Milling and Isoelectric Precipitation

The dry yellow peas were blended in distilled water, with a ratio of 1:5 (w/v) of peas to water, at room temperature for 10 hours. The de-hulled and soaked peas were grinded in the presence of oxygen with a ratio of 1:4 (w/v) of wet peas to water. Once separated by a screw extruder, the water extract was centrifuged at 3,000 g for 15 minutes in order to remove starch and internal fiber, allowing a protein solution to be obtained. The protein solution was heated to 125-130° C. for 30 seconds, directly through steam injection in order to inactivate the endogenous enzyme, and then cooled to 50° C. with the plate heat exchanger, and then precipitated by adjusting the pH to 4.5 with 2 mol L⁻¹ HCl and centrifuged at 3,000 g for 15 minutes. The protein curd was re-suspended in distilled water with a ratio of 1:1 (w/v) of curd to water, in order to obtain a solids content ranging from 10% to 12%, and neutralized to a pH of 7.0 with 2 mol L⁻¹ NaOH. These steps of the process are followed by high pressure homogenization (20 MPa), heating treatment (120° C., 30 s), flash evaporation, and spray drying (180° C., 80° C.). The sample “Prior art process #2” was obtained.

### Example 3: Inventive Process #1, Involving High Temperature Acid Wash of the Extracted Proteins

The dry yellow peas were de-hulled and blended in distilled water with a ratio of 1:5 (w/v) of peas to water at room temperature. The peas were then grinded at a pH of 8.5-9.0 in the presence of oxygen. Once separated by a screw extruder, the solution was centrifuged at 3,000 g for 15 minutes in order to remove insoluble substances (mostly starch and internal fibers), and a raw protein solution was obtained. The raw protein solution was then adjusted to a pH of 7.0-7.5 with 2 M HCl and heated to 125-130° C. for 30 seconds directly through steam injection in order to inactivate the endogenous enzyme, and then cooled to 50° C. using the plate heat exchanger. The proteins were then precipitated by adjusting the pH to 4.5 with 2 mol L−1 HCl and centrifuged at 3,000 g for 15 min. The protein curd was isolated by centrifugation and immersed with 2 parts weight of 90° C. distilled water, which was adjusted to a pH of 4.5.

After 30 minutes of contact time under gentle stirring, the protein solution was pumped into a plate filter in order to separate the protein from the water, and the obtained protein curd was suspended in distilled water in order to obtain a solids content ranging from 10% to 12%, and an adjusted pH of 7.0 with 2.0 M NaOH. Then, it was reheated to 125-130° C. for 30 seconds and spray dried (180° C., 80° C.). The sample “inventive process #1-HTAW alone with oxygen” was obtained.

In order to demonstrate synergy between high temperature and acidic pH wash, Inventive process #1 was also reproduced three times with slight modifications:
Low temperature wash (50° c.) and at acid wash pH (4.5)
High temperature at high pH (7.0) and at acidic wash pH (4.5)
Low temperature wash (50° c.) and at neutral wash pH (7)

By comparing the results of example 3, this helps explain how an innovative protein isolate is only reachable with a combination of both parameters.

### Example 4: Inventive Process #2 Involving High Temperature Acid Wash and Low Oxygen Milling

The dry yellow peas were de-hulled and blended in distilled water with a ratio of 1:5 (w/v) of peas to water at room temperature. The peas were then grinded in oxygen-free water below 200 μg/I with a ratio of 1:4 (w/v), and then separated with a screw extruder. After standing for 1 hour under a nitrogen atmosphere, the protein solution was centrifuged at 3,000 g for 15 minutes to remove insoluble substances (mostly starch and internal fibers), and then a raw protein solution was obtained. The raw protein solution was adjusted to a pH of 7.0˜7.5 while still under nitrogen atmosphere, and then heated directly through the steam injection to 125˜130° C. for 30 seconds, and finally cooled to 30-40° C. using the plate heat exchanger. The protein was then precipitated by adjusting to a pH of 4.5 with 2 mol L−1 HCl and centrifuged at 3,000 g for 15 minutes.

The protein curd was isolated by centrifugation and immersed with 2 parts weight of 90° C. distilled water that was adjusted to a pH of 4.5. After 30 minutes of contact time under gentle stirring, the protein solution was pumped into a plate filter in order to separate the protein from the water. After repeating this step two times with 90° C. water at a pH of 4.5, the protein solution was pumped into a plate filter to separate the protein from the water., and the obtained protein curd was suspended in distilled water in order to obtain a solids content ranging from 10% to 12%, and an adjusted pH of 7.0 with 2.0 M NaOH. This was followed by reheating to 125-130° C. for 30 s and spray drying (180° C., 80° C.). The sample “inventive process #2—HTAW combing with low oxygen milling” was obtained.

In order to show synergy of oxygen-free milling and high temperature and acidic pH wash, Inventive process #2 was also reproduced without a high temperature and acidic pH wash.

### Example 5: Organoleptic Testing Process

Sample preparation: 4% protein powder dissolved in deionized water at room temperature (around 23° c.)

Panelist: 10 trained people

Sensory evaluation is based on 3 descriptors: beany, bitter and astringent. The scale for each descriptor is between 1 and 10 with, with 10 being the best score and 1 being the worst. The final sensory score is taken from the average of the total amongst all panelists and in all 3 categories.

### Example 6: Comparison of Prior Art and Inventive Protein Isolate Produced in Examples 1 Through 4

Table 1 below compares all protein isolates produced in examples 1 through 4. Reference commercial protein isolates are also included in the comparison.

TABLE 1

| | | | | | | | Sum of 4 | | | | |
|---|---|---|---|---|---|---|---|---|---|---|---|
| | | | | | | | volatiles | | | | |
| | | | | | | | listed in | | | | |
| | | | | | | | the 4 | | | | |
| | | | | | | | column | Total | | | |
| | | | | 1-octen- | 2-penty- | (E)-2,4- | on the | volatiles | Saponin | DDMP | Total |
| | | Sensory | Hexanal | 3-ol | furan | Heptadienal | Left | compounds | B | saponin | saponins |
| | | score | (μg/g) | (μg/g) | (μg/g) | (μg/g) | (μg/g) | (μg/g) | (mg/g) | (mg/g) | (mg/g) |
| Prior art | Prior art process | 10 | 3.23 | 0.01 | 0.02 | 0.02 | 3.28 | 4.23 | 3.17 | 1.43 | 4.6 |
| processes | #1—solvent | | | | | | | | | | |
| and | Prior art process | 2 | 17.47 | 0 | 0.28 | 0.28 | 18.03 | 40.82 | 6 | 2.17 | 8.17 |
| products | #2—soaking | | | | | | | | | | |
| | and wet milling | | | | | | | | | | |
| | Commercial product | 3.4 | 8.8 | 1.82 | 4.11 | 4.11 | 18.84 | 32.05 | 1.88 | 0.99 | 2.87 |
| | #1—Propulse S | | | | | | | | | | |
| | Commercial product | 2.4 | 16.37 | 0.67 | 2.66 | 2.66 | 22.36 | 36.89 | 1.52 | 1.58 | 3.1 |
| | #2—Purls 860 | | | | | | | | | | |
| | Commercial product | 2.9 | 12.64 | 1.5 | 4.18 | 4.18 | 22.5 | 36.47 | 1.8 | 1.15 | 2.95 |
| | #3—Pisane F9 | | | | | | | | | | |
| | Commercial product | 4 | 16.88 | 0.51 | 2.11 | 2.11 | 21.61 | 34.15 | 4.15 | 1.78 | 5.93 |
| | #4—Nutralys F85F | | | | | | | | | | |
| | Commercial product | 3 | 20.91 | 0.61 | 2.28 | 2.28 | 26.08 | 39.97 | 3.64 | 1.5 | 5.14 |
| | #5—Nutralys S85F | | | | | | | | | | |
| Inventive | Inventive process | 8 | 1.21 | 0.05 | 0.43 | 0.43 | 2.12 | 6.43 | 2.84 | 0.66 | 3.5 |
| process | #1—HTAW | | | | | | | | | | |
| | alone with oxygen | | | | | | | | | | |
| | Comparison with low | 7 | 5.59 | 0.06 | 0.52 | 0.52 | 6.69 | 14.03 | 3.15 | 0.75 | 3.9 |
| | temperature wash (50° C.) | | | | | | | | | | |
| | Comparison with neutral | 6.3 | 5.47 | 0.25 | 0.61 | 0.61 | 6.94 | 13.54 | 1.04 | 0.4 | 1.44 |
| | pH wash (at 90° C.) | | | | | | | | | | |
| | Comparison with neutral | 5.6 | 7.57 | 0 | 1.39 | 1.39 | 10.35 | 18.63 | 1.28 | 0.56 | 1.84 |
| | pH wash (at 50° C.) | | | | | | | | | | |
| | Inventive process | 9 | 0.8 | 0.03 | 0 | 0 | 0.83 | 4.84 | 3.87 | 0.45 | 4.32 |
| | #2—HTAW combined | | | | | | | | | | |
| | with low oxygen milling | | | | | | | | | | |
| | Oxygen free grinding | 5 | 3.63 | 0.37 | 0.23 | 0.23 | 4.46 | 18.01 | 4.97 | 2.79 | 7.76 |
| | alone, without HTAW | | | | | | | | | | |

The results clearly show that:
The better samples were, as predicted, obtained through the solvent reference process
Only processes involving high temperature acid wash lead to an isolate with a sensory score above 7 and total volatile compounds below 10 μg/g, which means that they had the closest numbers to the solvent reference process.
The combination of high temperature acid wash with oxygen free grinding leads to an even better quality, meaning the total volatile compounds are below 5 μg/g. Using oxygen free grinding alone produces mid-range quality product

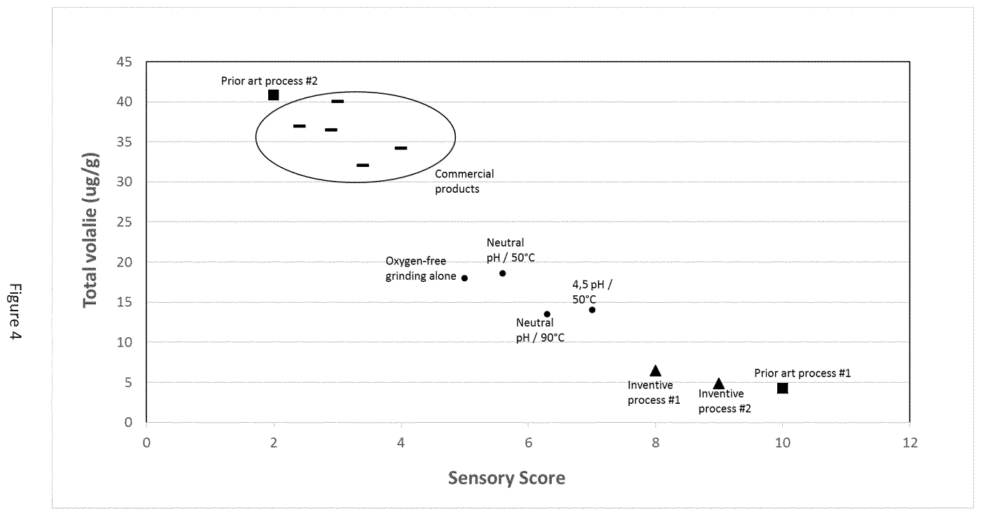

In conclusion, FIG. 4 clearly shows that the process of the invention leads to a level of protein quality that has never been reached before. Its sensory score and volatile contents are closer to the solvent reference than commercial protein. No other solvent used is as interesting from an industrial point of view.

### Example 7: Comparison of Solubility in Water Between Prior Art Isolates and Inventive Isolates

Solubility will be measured using following protocol:
2.0 g of sample and 100 g of distilled water are placed in a 400 mL beaker at 20° C.
pH is adjusted at 6 or 7, with 1N HCl and/or 1N NaOH and the mixture is made up to exactly 200.0 g with distilled water.
This mixture is stirred for 30 minutes and then centrifuged for 15 minutes at 3000×g.
After centrifugation, exactly 25.0 g of supernatant are withdrawn into a crystallizing dish (m1). The dish is placed in an oven at 103° C. until it reaches a constant mass (m2).
Solubility=((m2−m1)/25)*100, expressed in g of dry matter per 100 g of solution

In order to be comparable, Hydrolysis Degree of all protein samples are measured using OPA method, which is described below.

Principle:

The “amino nitrogen” groups of the free amino acids of the sample react with N-acetyl-L-cysteine and o-phthalyldialdehyde (OPA) to form isoindole derivatives.

The amount of isoindole derivative formed during this reaction is stoichiometric with the amount of free amino nitrogen. It is the isoindole derivative that is measured by the increase in absorbance at 340 nm.

Procedure:

Introduce an accurately weighed test sample P* of the sample to be analyzed into a 100 ml beaker. (This test sample will be from 0.5 to 5.0 g as a function of the amino nitrogen content of the sample.)

Add about 50 ml of distilled water, homogenize and transfer into a 100 ml measuring cylinder, add 5 ml of 20% SDS and make up to the volume with distilled water; stir for 15 minutes on a magnetic stirrer at 1000 rpm.

Dissolve 1 tablet of flask 1 of the Megazyme kit in 3 ml of distilled water and stir until fully dissolved. Provide one tablet per test.

This solution No. 1 is to be prepared extemporaneously.

The reaction takes place directly in the spectrophotometer cuvettes.
Blank:
Introduce 3.00 ml of solution No. 1 and 50 μl of distilled water.
Standard:
Introduce 3.00 ml of solution No. 1 and 50 μl of flask 3 of the Megazyme kit.
Sample:

Introduce 3.00 ml of solution No. 1 and 50 μl of the sample preparation.

Mix the cuvettes and read the absorbance measurements (A1) for the solutions after about 2 minutes on the spectrophotometer at 340 nm (spectrophotometer equipped with cuvettes with a 1.0 cm optical path, which can measure at a wavelength of 340 nm, and verified according to the procedure described in the manufacturer's technical manual related thereto).

Start the reactions immediately by adding 100 μl of the OPA solution flask 2 of the Megazyme kit to the spectrophotometer cuvettes.

Mix the cuvettes and place them in darkness for about 20 minutes.

Next, read the absorbance measurements for the blank, the standard and the samples on the spectrophotometer at 340 nm.

Calculation Method:

The content of free amino nitrogen, expressed as a mass percentage of product per se, is given by the following formula:

$$[ {NH}_{2} \% crude ] = \frac{( {Δ A}_{sample} = {Δ A}_{blank} ) \times 3.15 \times 14.01 \times V \times 100}{6803 \times 0.05 \times 1000 \times m} = \frac{( {Δ A}_{sample} - {Δ A}_{blank} ) \times 12.974 \times V}{m \times 1000}$$

in which: ΔA=A2−A1

V=volume of the flask

m=mass of the test sample in g

6803=extinction coefficient of the isoindole derivative at 340 nm (in L·mol⁻¹·cm⁻¹).

14.01=molar mass of nitrogen (in g·mol⁻¹)

3.15=final volume in the cuvette (in ml)

0.05=test sample in the cuvette (in ml)

The degree of hydrolysis (DH) is given by the formula:

$$DH = \frac{Protein nitrogen ( \% )}{Amino nitrogen ( \% ) \times 100}$$

in which the protein nitrogen is determined according to the DUMAS method according to standard ISO 16634.

Table below resume all these analysis on Inventive Process isolates and also on Prior Art isolates:

| | | Solubility | Solubility |
|---|---|---|---|
| | | @ pH 6 | @ pH 7 |
| | | (g dry | (g dry |
| | | matter/ | matter/ |
| | Hydrolysis | 100 g of | 100 g of |
| | Degree | solution) | solution) |
| Inventive Process #1 | | 53.0 | 79.2 |
| Inventive Process #2 | | 52.8 | 74.2 |
| Propulse S | 4.6 | 20.7 | 36.1 |
| Puris 860 | 3.7 | 14.4 | 16.8 |
| Nutralys S85F | 4.6 | 20.8 | 57.1 |
| Nutralys F85F | 4.5 | 23.4 | 57.4 |

From lecture of above Table, it is clear that inventive process samples #1 and #2 are the only samples that possess a solubility at pH 6 above 30%, preferably above 40%, more preferably around 50% and a solubility at pH 7 above 40%, preferably above 60%, more preferably above 70%.

This difference can't be explained by hydrolysis degrees which are in the same range: our inventive process has also an impact on the functional properties of inventive isolates, especially raising its solubility at pH 6 and 7.

1. A plant protein isolate containing less than 10 μg, preferably less than 5 μg of the sum of hexanal, 2-pentyl-furan, (E)-2,4, heptadienal and 1-octen-3-ol per gram of dry matter.

2. The plant protein isolate of claim 1, wherein the protein isolate is obtained from a leguminous plant, preferably from pea or fava bean, more preferably from pea.

3. The plant protein isolate of claim 1, containing less than 5 mg of total saponins per gram of dry matter.

4. A method for extracting a plant protein isolate according to claim 1, comprising the steps of:
(a) providing a protein containing seed, preferably leguminous seed, more preferably pea seed;
(b) milling said seed;
(c) suspending the milled seed in water;
(d) extracting proteins from said milled suspension;
(e) washing the extracted proteins with water at temperature between 60° C. and 100° C., preferably between 75° c. and 95° c., and pH in the range of 4 and 5.5, preferably between 4.5 and 5;
(f) optionally passing the washed proteins obtained at the end of step (e) through a shearing pump or a homogenizer to improve protein functionality; and
(g) optionally drying the proteins obtained in step (e) or (f).

5. The method of claim 4, wherein the volume of water needed to wash the proteins in step (e) is between 1 and 5 times the quantity of protein suspension, but preferably less than 3 times.

6. The method of claim 4, wherein the milling of step (b) is carried out in the absence of oxygen.

7. The method of claim 4, wherein the milling of step (b) is carried out at residual concentration of dioxygen of less than 300 μg/l, more preferably less than 200 μg/l.

8. The method of claim 4, wherein the pH in step (e) is adjusted using food grade acids, in particular including hydrochloric acid, citric acid or sulfuric acid.

9. The method of claim 4, wherein the washed proteins obtained at the end of step (e) or (f) are dried using a spray-dyer, preferably a multistage spray-dryer.

10. The method of claim 4, wherein the milling of step (b) is a wet milling step.

11. The method of claim 4, wherein the milling of step (b) is a dry milling step.
